(19) United States
(12) Patent Application Publication
(10) Pub. No.: US 2025/0174690 A1
(43) Pub. Date: May 29, 2025

(54) HYDROGEN TANK SYSTEM

(71) Applicant: TOYOTA JIDOSHA KABUSHIKI KAISHA, Toyota-shi Aichi-ken (JP)

(72) Inventor: Shota YAMAMOTO, Toyota-shi Aichi-ken (JP)

(73) Assignee: TOYOTA JIDOSHA KABUSHIKI KAISHA, Toyota-shi Aichi-ken (JP)

(21) Appl. No.: 18/945,031

(22) Filed: Nov. 12, 2024

(30) Foreign Application Priority Data
Nov. 28, 2023 (JP) 2023-200689

(51) Int. Cl. H01M 8/04746; B60L 50/70; B60L 58/30; H01M 8/04082

(52) U.S. Cl. CPC H01M 8/04753; H01M 8/04201; B60L 50/70; B60L 58/30; H01M 2250/20

(57) ABSTRACT

In a system where the hydrogen filling piping and the hydrogen supply piping are common, it is possible to promptly respond even when a problem occurs in the hydrogen filling side. Hydrogen tank, a hydrogen consumption device, and a hydrogen tank system having a hydrogen filling port, at least a portion of the piping from the pipe and the hydrogen tank to the hydrogen consuming apparatus from the hydrogen filling port to the hydrogen tank is common, the control device, before the hydrogen supply to the hydrogen consuming apparatus after the hydrogen charging to the hydrogen tank, determines by acquiring the internal pressure of the pipe in the common portion of the pipe, performs control for notifying.

### CROSS-REFERENCE TO RELATED APPLICATIONS

This application is based upon and claims the benefit of priority of the prior Japanese Patent Application No. 2023-200689, filed on Nov. 28, 2023, the entire contents of which are incorporated herein by reference.

### FIELD

The present disclosure relates to a hydrogen tank system mounted on a vehicle or the like.

### BACKGROUND

Patent Document 1 discloses that, in a hydrogen storage unit, a plurality of hydrogen tanks are mounted on a manifold, hydrogen is filled in a plurality of tanks via a manifold, and hydrogen is supplied from a plurality of tanks via a manifold.

### CITATION LIST

### Patent Literature

Patent Document 1: JP 2016-157522 A

### SUMMARY

### Technical Problem

In order to simplify the hydrogen filling to the hydrogen tank and the route to be used for hydrogen use, it is conceivable that both pipes are common. However, by sharing the piping, when the check valve of the filling port of the hydrogen fails, there is a possibility that hydrogen in the hydrogen tank is released from the filling port after hydrogen filling.

In view of the above problems in the present disclosure, in the system in which the hydrogen filling pipe and the hydrogen supply pipe is common, to provide a hydrogen tank system capable of responding quickly even when a problem occurs in the hydrogen filling side.

### Solution to Problem

The present application is a hydrogen tank, a hydrogen consumption device, and a hydrogen tank system having a hydrogen filling port, at least a portion of the piping from the piping and the hydrogen tank to the hydrogen consuming apparatus from the hydrogen tank from the hydrogen filling port is common, the control device, before hydrogen supply to the hydrogen consuming apparatus after hydrogen filling into the hydrogen tank, to obtain the internal pressure of the piping in the common portion of the pipe, the internal pressure to perform control for notifying when it becomes below a predetermined pressure, discloses a hydrogen tank system.

Further, the present application, a hydrogen tank, a hydrogen tank system having a hydrogen consumption device, and a hydrogen filling port, at least a part of the pipe and the pipe from the hydrogen tank to the hydrogen consumption device from the hydrogen tank from the hydrogen filling port is common, the control device, in the common part of the pipe, the pressure P1 after filling of hydrogen into the hydrogen tank, and the pressure P2 after a predetermined time has elapsed after filling of the hydrogen into the hydrogen tank before supplying the hydrogen to the hydrogen consumption device, to obtain a pressure P1 and pressure P2 when the difference between the pressure and the pressure P2 becomes a predetermined value or more, to disclose a hydrogen tank system.

In the above hydrogen tank system, the control device, prior to performing the notification, or at the same time, may be configured to close the valve of the hydrogen tank.

### Effects

According to the present disclosure, in the system in which the hydrogen filling pipe and the hydrogen supply pipe are common, even when a problem occurs in the hydrogen filling side, it is possible to detect and notify the problem quickly, it is possible to quickly respond.

### BRIEF DESCRIPTION OF DRAWINGS

FIG. 1 is a diagram showing an outline of a vehicle 1.

FIG. 2 is a diagram illustrating a hydrogen filling device 50.

FIG. 3 is a diagram illustrating a hydrogen tank system 10.

FIG. 4 is a diagram illustrating a control device 20.

FIG. 5 is a diagram illustrating a notification control S10 according to the form 1.

FIG. 6 is a diagram illustrating a notification control S20 according to Form 2.

### DESCRIPTION OF EMBODIMENTS

### 1. Vehicle

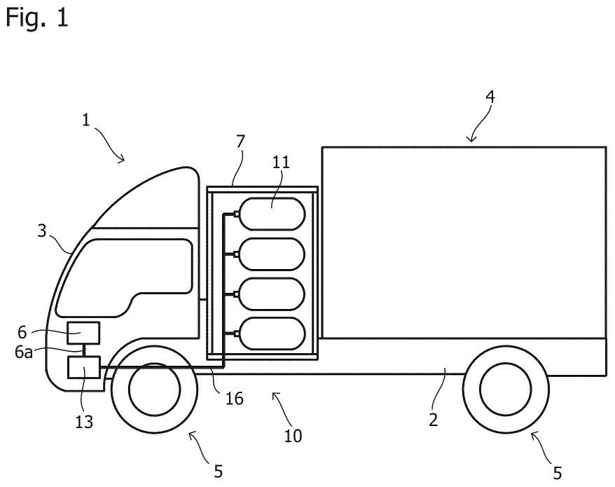

1 schematically represented an overview of a vehicle 1 according to one example in which a hydrogen tank system 10 of the present disclosure is placed. Incidentally, since the hydrogen tank system 10 will be described later with reference to another diagram, the hydrogen tank 11 of the hydrogen tank system 10 in FIG. 1, the hydrogen consumption device (fuel cell in the present embodiment) 13, and, shows only the hydrogen supply dedicated pipe 16.

Vehicle 1 of the present embodiment is a large vehicle (truck), the bogie 2, the operation unit 3 disposed in front of the bogie 2, the cargo bed portion 4 disposed in the rear of the bogie 2, the wheel portion 5 provided in the lower portion of the bogie 2, an electric motor 6 for driving the vehicle 1, and a hydrogen tank system 10 having a compartment 7. Here, the truck is shown as a large vehicle, it can be applied to a bus or the like is not limited thereto. It is also not limited to large vehicles and can be applied to ordinary passenger cars.

Vehicle 1 supplies the hydrogen from the hydrogen tank 11 of the hydrogen tank system 10 to the fuel cell 13 is a hydrogen consuming apparatus through the hydrogen supply dedicated pipe 16 supplies air to the fuel cell 13 from the air acquiring device (not shown). The fuel cell 13 generates power by oxidizing hydrogen by supplied air (oxygen), supplies power to the electric motor 6 through the electric wire 6a to drive the electric motor 6, the vehicle 1 obtains the propulsion force.

Driving of the electric motor 6 by the fuel cell 13 using hydrogen as a fuel in such a vehicle 1 is as is known.

Further, the vehicle 1 of the present embodiment as will be described later, the hydrogen supplied from the hydrogen filling apparatus 50 provided in the hydrogen station is received by the hydrogen tank system 10, and stores the hydrogen in the hydrogen tank 11.

### 2. Hydrogen Charging Equipment

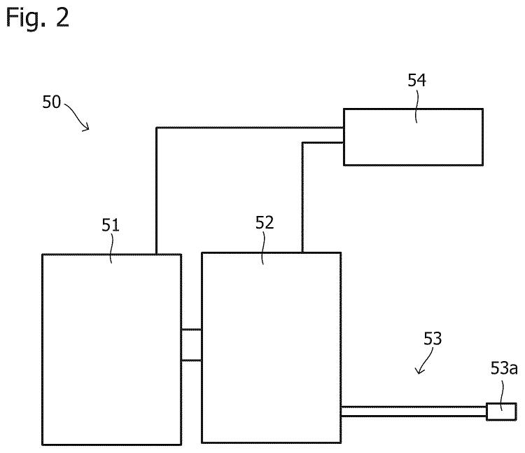

FIG. 2 represents a diagram illustrating an outline of a hydrogen filling apparatus 50 for supplying hydrogen to the hydrogen tank system 10.

The hydrogen filling device 50 includes an accumulator 51 which hydrogen is sealed, a compressor 52 for compressing (boosting) the hydrogen discharged from the accumulator 51 to the pipe, the hydrogen supply pipe 53 for supplying the hydrogen boosted from the compressor 52 to the hydrogen tank system 10 of the vehicle 1, and a control device 54 for controlling the hydrogen supply. Filling of hydrogen is performed by the nozzle 53a provided at the distal end of the hydrogen supply pipe 53 is connected to the receptacle 12 as a hydrogen filling port provided in the hydrogen tank system 10 of the vehicle 1.

One or more hydrogen filling devices 50 are located at the hydrogen station where the hydrogen is supplied.

That is, there is a hydrogen station having one hydrogen charging device 50 or a hydrogen station having two or more hydrogen charging devices 50.

### 3. Hydrogen Tank System

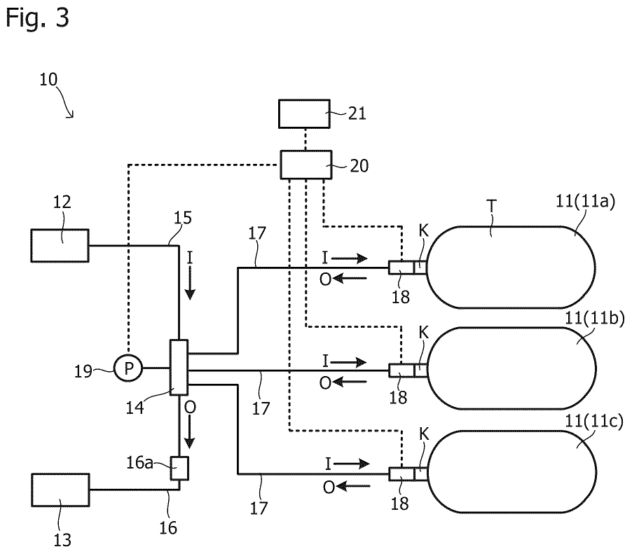

As described above, the vehicle 1 of the present embodiment is provided with a hydrogen tank system 10. FIG. 3 conceptually illustrates the configuration of a hydrogen tank system 10 in accordance with one form. Hydrogen tank system 10 in the present embodiment as can be seen from FIG. 3, the hydrogen tank 11, the receptacle 12, the fuel cell 13, the distributor 14, the hydrogen filling dedicated pipe 15, the hydrogen supply dedicated pipe 16, the common pipe 17, the on-off valve 18, the pressure gauge 19, the control device 20, and a notification device 21.

Each configuration will be described below.

### 3.1. Hydrogen Tank

The hydrogen tank 11 is a container for storing hydrogen, and hydrogen is supplied from the hydrogen tank 11 to the fuel cell 13 as a hydrogen consuming device.

The specific structure of the hydrogen tank 11 is not particularly limited, and a known one which can be used as a hydrogen tank can be applied. Typically a hydrogen tank is a tank body T is a site for storing hydrogen, the inlet and outlet of the hydrogen of the tank body T, the opening and closing valve 18 is provided with a cap K to be arranged.

In this form, a plurality of hydrogen tanks 11 are provided (e.g., 3), and each hydrogen tank 11 is filled with hydrogen. Here, three hydrogen-tank 11 are arranged, and the sign is expressed in 11a, 11b, 11c in order to distinguish them. All of these hydrogen tanks 11 may have the same capacity, or hydrogen tanks of different capacities may be included.

### 3.2. Receptacle

The receptacle 12 is a member which functions as a hydrogen filling port, and hydrogen flows from the hydrogen supply device 50 to the hydrogen tank 11 by communicating the flow path between the hydrogen filling device 50 and the hydrogen tank system 10 by connecting the nozzle 53a of the hydrogen filling device 50 described above.

A check valve (not shown) is disposed in the receptacle 12, and a flow of hydrogen is allowed in a direction in which hydrogen is filled, and a flow of hydrogen is regulated in a reverse direction (in which hydrogen flows out of the receptacle 12).

The specific shape of the receptacle 12 is not particularly limited, and a known form can be used.

### 3.3. Fuel Cell

The fuel cell 13 is an apparatus that consumes supplied hydrogen, and is one embodiment of a hydrogen consuming apparatus. The fuel cell 13 receives the supply of hydrogen from the hydrogen tank 11 as described above, and also receives the supply of air from an air hole (not shown) to generate electricity. A specific configuration of the fuel cell 13 is not particularly limited, and a known one can be used.

### 3.4. Distributor

The distributor 14 is a member for branching or merging the flow path by connecting a plurality of pipes, in the present embodiment, the pipe from the receptacle 12 (hydrogen filling dedicated pipe 15), the piping to the fuel cell 13 (hydrogen supply dedicated pipe 16), and the piping to form a flow path with the hydrogen tank 11 (common pipe 17) is connected, all of the flow path in the distributor 14 is communicated.

The specific shape of the distributor 14 is not particularly limited, and a known one can be used.

### 3.5. Piping

The piping is a piping that forms a flow path for hydrogen.

Hydrogen filling dedicated pipe 15 is a pipe to form a hydrogen flow path between the receptacle 12 and the distributor 14 is a pipe through which hydrogen flows during hydrogen filling.

Hydrogen supply dedicated pipe 16 is a pipe to form a hydrogen flow path between the distributor 14 and the fuel cell 13, when supplying hydrogen to the fuel cell 13 in order to consume hydrogen (during hydrogen supply) is a pipe through which hydrogen flows. Incidentally, on-off valve 16a is disposed in the hydrogen supply-only pipe 16 is configured to be able to allow and regulate the flow of hydrogen.

Common pipe 17 is a pipe for forming a hydrogen flow path from the distributor 14 to each of the hydrogen tanks 11, both during hydrogen filling and during hydrogen supply is a pipe through which hydrogen flows.

These pipes are arranged so that the flow paths merge in the distributor 14 as described above.

### 3.6. Open/Close Valve

The on-off valve 18 is an ON-OFF valve to be in a fully open or fully closed condition only, and is disposed in the cap K of the hydrogen tank 11 in this form. Thus, it is possible to switch the allowance and regulation of taking in and out of hydrogen to the hydrogen tank 11.

Switching valve 18 in the present embodiment is a valve which can be rapidly opened and closed by the force of the electromagnet, an ON-OFF valve to be in the status of only one of the fully open or fully closed. It is possible to use a known solenoid valve as on-off valve 18. Then, the on-off valve 18 is electrically connected to the controller 20, ON-OFF is configured to be able to control based on a signal from the controller 20.

Note that, although the opening/closing valve 18 is disposed in the hydrogen tank 11 in this embodiment, this embodiment is not limited thereto, and may be disposed at any position of the common pipe 17.

### 3.7. Pressure Sensor

A pressure sensor 19 is disposed in the distributor 14 and measures the pressure in the flow path (the pressure of hydrogen) in the distributor 14. In other words, the pressure in the flow path of the merged flow path of each of the above-described flow paths is measured. The type of the specific pressure sensor is not particularly limited, and a known one may be applied.

Pressure sensor 19 is electrically connected to the controller 20, and is configured to be able to transmit pressure measurement results to the controller 20.

### 3.8. Controller

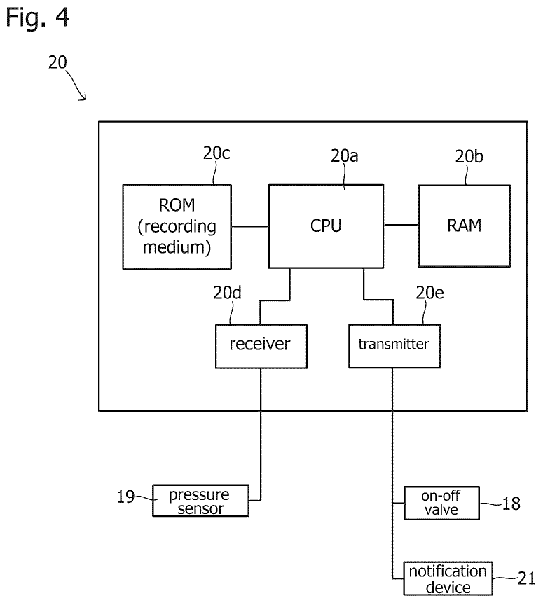

Controller 20 performs an operation by obtaining the pressure information from the pressure sensor 19, for example, or to notify by operating the notification device 21, controls or to regulate the flow of hydrogen by operating the on-off valve 18. As conceptually illustrated in FIG. 4, the control unit 20 includes a CPU (Central Processing Unit that is a processor and performs operations, a central processing unit (20a), a RAM (Random Access Memory) 20b that functions as a workspace, a ROM (Read-Only Memory) 20c that functions as a recording medium, a receiver 20d that is an interface that accepts information regardless of wired or wireless to the control unit 20, and a transmitter 20e that is an interface that transmits information regardless of wired or wireless from the control unit 20 to the outside.

Thus the control unit 20 receives the information by the pressure sensor 19 is connected to the receiver 20d, the on-off valve 18 to the transmitter 20e, the notification device 21 is connected It is configured to be able to send a signal to the on-off valve 18 and the notification device 21.

The control device 20 processes information from the pressure sensor 19, it is determined whether the abnormal state, a program for notification control for operating the on-off valve 18 and the notification device 21 is stored. In controller 20, CPU 20a, RAM 20b and ROM 20c as a hardware-resource and the program work together. Specifically, CPU 20a performs a computer program recorded in ROM 20c in a RAM 20b that functions as a working area, thereby determining whether or not the computer is in an abnormal state based on the pressure information from the pressure sensor 19, and operates the opening/closing valve 18 and the notification device 21 to perform appropriate notification control. The data acquired or generated by CPU 20a is stored in RAM 20b. In addition, a recording medium may be separately provided inside or outside the control device 20, and a program and various data may be recorded therein.

In this embodiment, the control device 20 acquires the information from the pressure sensor 19 via the receiver 20d. The control device 20 executes a computer program recorded on a ROM 20c or other recording medium and performs computational processing, while using a database recorded on a ROM 20c or other recording medium, based on the acquired data, and records the result on a RAM 20b or a recording medium. The content of the specific notification control by the control device 20 will be described later. Signal from the transmitter 20e to the on-off valve 18 and the notification device 21 is transmitted on the basis of the determination, the on-off valve 18 and the notification device 21 operates according to this signal.

Such a control device 20 can typically be configured by a computer.

### 3.9. Informing Device

The notification device 21 is a device for outputting necessary information to the outside. The specific method of notification is not particularly limited, and examples thereof include sound, light, and display of characters and patterns, and combinations thereof. The device is a speaker if sound, illumination if light, display if display, or the like.

The notification device 21 is electrically connected to the control device 20, and is configured to receive a signal from the control device 20 and perform the above-described notification.

### 4. Normal Control

Before describing the scene where it is necessary to perform the notification control, it will be described normal operation of the hydrogen tank system 10.

### 4.1. Filling the Hydrogen Tank

The filling of hydrogen into the hydrogen tank 11 is performed by connecting a nozzle 53a provided at a distal end of the hydrogen supply pipe 53 of the hydrogen filling device 50 described above to a receptacle 12 as a hydrogen filling port provided in the hydrogen tank system 10 of the vehicle 1 and supplying hydrogen from the hydrogen filling device 50.

Thus, as indicated by the arrow I in FIG. 3, hydrogen from the receptacle 12 hydrogen filling dedicated pipe 15, distributor 14, and passes through each common pipe 17, each hydrogen tank 11 passes through the on-off valve 18 it is filled.

At this time, the on-off valve 16a of the hydrogen supply dedicated pipe 16 is closed, the flow of hydrogen in the hydrogen supply dedicated pipe 16 is regulated. Closing of the on-off valve 16a may be performed by the control device 20. At that time the on-off valve 16a and the control device 20 is electrically connected.

### 4.2. Hydrogen Consumption by Hydrogen Consumption Device

In a situation where power is generated by the use of the fuel cell 13 and hydrogen is consumed as when the vehicle is moved by the electricity, the on-off valve 16a is opened and hydrogen is supplied to the fuel cell 13. Specifically, hydrogen flows out from each hydrogen tank 11 (from the hydrogen tank 11 when one hydrogen tank 11 selected from a plurality of hydrogen tanks 11 is used) as indicated by an arrow O in FIG. 3, and hydrogen is supplied to the fuel cell 13 through the common pipe 17, the distributor 14, and the hydrogen supply dedicated pipe 16.

Incidentally, since the check valve is disposed in the receptacle 12 as described above, it will not normally leak hydrogen to the outside from the receptacle 12.

### 4.3. Effect, etc.

Thus, according to the hydrogen tank system 10 of the present embodiment, since the piping is common in at least a portion (common pipe 17) of the piping for supplying the pipe and hydrogen for filling hydrogen, it is possible to simplify the system. This also contributes to vehicle weight reduction, etc.

### 5. Alarm Control

Here, when performing the “consumption of hydrogen by the hydrogen consuming apparatus” described above, for example, if there is a failure in the check valve of the receptacle 12 or damage to the sealing material of the receptacle 12 occurs, a portion of the hydrogen from the distributor 14 flows back to the receptacle 12 through the hydrogen filling dedicated pipe 15, leaking problems to the outside occurs. The notification control is a control for promptly reporting a situation when such a problem occurs to encourage a smooth response. The form example is described below. These controls are performed by the above-described control device 20.

In some embodiments, such notification control after the “filling of the hydrogen tank” described above, before (before the opening and closing valve 16a is opened) of the “consumption of hydrogen by the hydrogen consuming device” is to be performed.

### 5.1. Form Example 1

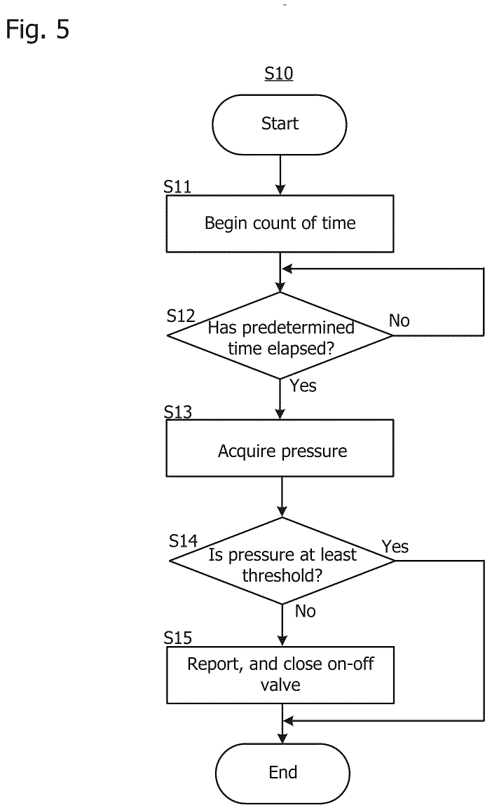

FIG. 5 shows the flow of the notification control S10 according to the form 1. Each process is described below.

### 5.1.1. Process S11

In the process S11, counting of times begins. Although there is no particular limitation on the timing of starting, there may be mentioned a case where hydrogen is supplied to the fuel cell 13 immediately after the filling of hydrogen into the hydrogen tank 11 is completed (before the opening/closing valve 16a is opened).

### 5.1.2. Process S12

In the process S12, it is determined whether a predetermined period has elapsed from the process S11. If the predetermined period has elapsed, it is considered Yes and the process proceeds to S13. If the predetermined time has not elapsed, the time is counted as No and counting is continued.

Although the predetermined time depends on the time required for system activation of the vehicle, it is appropriate to assume that the time is within a few seconds, considering the general time required for system activation of automobiles in recent years.

### 5.1.3. Process S13

In the process S13, the control unit 20 from the pressure sensor 19 acquires the pressure reading.

### 5.1.4. Process S14

In the process S14, it is determined whether the pressure obtained by the process S13 is equal to or higher than the threshold. Although the specific value of the threshold value is not particularly limited here, it can be considered as an extent that the pressure is considered to be unnaturally reduced even though hydrogen is not consumed after the hydrogen is filled. Specific values are not particularly limited, for example, if the pressure of the degree obtained by subtracting 10 MPa from the maximum pressure after filling of the hydrogen tank 11 (pressure set at the time of pressure and filling is said to be full in the normal hydrogen filling), apparently abnormal (hydrogen gas leakage or pressure sensor failure) it can be considered.

Since the pressure in the process S14 is no problem such as leakage occurs if the threshold or more, and terminates the notification control S10 is a Yes.

If the pressure is lower than the threshold in the process S14, a leak may have occurred. Therefore, the process proceeds to the process S15 with No.

### 5.1.5. Process S15

In process S15, it is notified by the notification device 21 that there is a possibility that leakage has occurred. This is performed by the control unit 20 transmits a signal to that effect to the notification device 21. Also, the opening and closing valve 18 may be closed at the same time or prior thereto. This may stop further hydrogen leakage from the receptacle 12. Closing of the on-off valve 18 is also performed by the control device 20 transmits a signal to that effect to the on-off valve 18.

### 5.1.6. Effect, etc.

According to the notification control S10, in the hydrogen tank system 10 to which the common pipe 17 is applied, even if there is a problem in which hydrogen leaks from the hydrogen filling port or the like, promptly notifying the situation it is possible to promptly urge a smooth response.

Together by closing the on-off valve 18, it is also possible to prevent the occurrence of further leakage.

### 5.2. Form Example 2

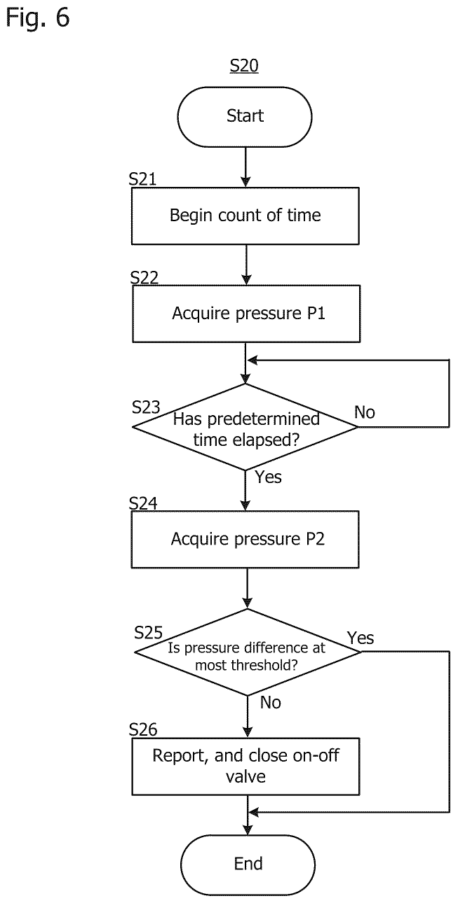

FIG. 6 shows the flow of the notification control S20 according to the form 2. Each process is described below.

### 5.2.1. Process S21

In the process S11, counting of times begins. Although there is no particular limitation on the timing of starting, there may be mentioned a case where hydrogen is supplied to the fuel cell 13 immediately after the filling of hydrogen into the hydrogen tank 11 is completed (before the opening/closing valve 16a is opened).

### 5.2.2. Process S22

In the process S22, the control unit 20 from the pressure sensor 19 acquires the pressure P1 is the pressure reading.

### 5.2.3. Process S23

In the process S23, it is determined whether a predetermined period has elapsed from the process S21. If the predetermined period has elapsed, it is considered Yes and the process proceeds to S24. If the predetermined time has not elapsed, the time is counted as No and counting is continued.

Although the predetermined time depends on the time required for system activation of the vehicle, it is appropriate to assume that the time is within a few seconds, considering the general time required for system activation of automobiles in recent years.

### 5.2.4. Process S24

In the process S24, the control unit 20 from the pressure sensor 19 acquires the pressure P2 is a pressure reading.

### 5.2.5. Process S25

In the process S25, it is judged whether the differences between the pressure P1 obtained by the process S22 and the pressure P2 obtained by the process S24 are below the thresholds. Although the specific value of the threshold value is not particularly limited here, it can be considered as an extent that the pressure is considered to be unnaturally reduced even though hydrogen is not consumed after the hydrogen is filled. Although there is no particular limitation on the specific value, it can be considered to be obviously abnormal (hydrogen gas leakage or failure of a pressure sensor) when, for example, a decrease of about 10 MPa or more is caused.

Since the pressure in the process S25 is no problem such as leakage occurs if below the threshold, and terminates the notification control S20 is a Yes.

If the pressure is greater than the threshold in the process S25, a leak may have occurred. Therefore, the process S26 is considered to be No.

### 5.2.6. Process S26

In process S26, it is notified by the notification device 21 that there is a possibility that leakage has occurred. This is performed by the control unit 20 transmits a signal to that effect to the notification device 21. Also, the opening and closing valve 18 may be closed at the same time or prior thereto. Thus, leakage of hydrogen from the receptacle 12 can be stopped. Closing of the on-off valve 18 is also performed by the control device 20 transmits a signal to that effect to the on-off valve 18.

### 5.2.7. Effect, etc.

According to the notification control S20, in the hydrogen tank system 10 to which the common pipe 17 is applied, even if there is a problem in which hydrogen leaks from the hydrogen filling port or the like, promptly notifying the situation it is possible to promptly urge a smooth response.

Together by closing the on-off valve 18, it is also possible to prevent the occurrence of further leakage.

Further, in the present embodiment, since the determination takes the differences between the two pressures (P1, P2) that have passed through a predetermined time-elapsed, even if there is variation for each system, it is possible to further improve the accuracy of the determination of the leakage.

### REFERENCE SIGNS LIST

1 . . . . Vehicle, 10 . . . hydrogen tank system, 11 . . . hydrogen tank, 12 . . . receptacle (hydrogen 5 filling port), 13 . . . fuel cell (hydrogen consuming device), 14 . . . distributor, 15 . . . dedicated piping for hydrogen filling, 16 . . . dedicated piping for hydrogen supply, 17 . . . common piping, 18 . . . on-off valve, 19 . . . pressure sensor, 20 . . . controller, 21 . . . notification device

What is claimed is:

1. A hydrogen tank system comprising:
a hydrogen tank;
a hydrogen consuming device; and
a hydrogen filling port, wherein
at least part of a pipe from the hydrogen filling port to the hydrogen tank is same as at least part of a pipe from the hydrogen tank to the hydrogen consuming device, and
after the hydrogen tank is filled with hydrogen and before the hydrogen is supplied to the hydrogen consuming device, a control unit acquires an internal pressure at the same part of the pipes, and reports when the internal pressure is at most a predetermined pressure.

2. A hydrogen tank system comprising:
a hydrogen tank;
a hydrogen consuming device; and
a hydrogen filling port, wherein
at least part of a pipe from the hydrogen filling port to the hydrogen tank is same as at least part of a pipe from the hydrogen tank to the hydrogen consuming device, and
a control unit acquires a pressure P1 at the same part of the pipes after the hydrogen tank is filled with hydrogen, and a pressure P2 at the same part of the pipes after a predetermined time has elapsed since the hydrogen tank is filled with the hydrogen and before the hydrogen is supplied to the hydrogen consuming device, and reports when a difference between the pressure P1 and the pressure P2 is at least a predetermined value.

3. The hydrogen tank system according to claim 1, wherein the control unit closes a valve of the hydrogen tank prior to or at the same time as said reporting.

4. The hydrogen tank system according to claim 2, wherein the control unit closes a valve of the hydrogen tank prior to or at the same time as said reporting.
